(19) United States
(12) Patent Application Publication
(10) Pub. No.: US 2002/0182305 A1
(43) Pub. Date: Dec. 5, 2002

(54) Dietary fibrous feed for domestic animals and method of producing the same

(76) Inventor: Nobuhisa Kawano, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/867,445

(22) Filed: May 31, 2001

(51) Int. Cl. A23L 1/325

(52) U.S. Cl. 426/643

(57) ABSTRACT

In this application is disclosed a dietary fibrous feed for domestic animals, i.e., reared animals, comprising the irreversible gel of glucomannan hydrate, and thereby, a low-calorie feed for domestic animals can be provided easily.

### BACKGROUND OF THE INVENTION

[1. Technical Field of the Invention]

The present invention relates to low-calorie dietary fibrous feed for domestic animals, which contains an irreversible gel of hydrate of dietary fiber glucomannan, and a method of producing such feed for domestic animals.

[2. Prior Art]

Recently, various pets such as dogs and cats and other domestic animals are increasingly reared in enclosures such as houses (indoors), cages or the like, so that various feeds have been commercialized for various domestic animals, and the convenient feeding thereof has taken root.

However, such feeds are generally nutrition-rich ones, and therefore, the feeding of nutrition-rich feeds to domestic animals in a limited enclosure (e.g., in houses) inevitably makes the domestic animals fat or sickly. Accordingly, keepers are currently anxious to adjust the feeding amount of the feeds for their reared animals and are trying to consume the excessive energy intaken by their animals by taking them out of doors, but the effects are not sufficient. In particular, there are no measures for maintaining health of the fondled pets, and the whole family suffer mentally and physically.

At present, the raw materials for pet foods of canned feedstuff become, along the suitability for living in the world of nature, nutrition-rich “composite nutritive foods” which satisfy preliminarily a nutrition requirement standard, from so-called feeds, and the use is mainly left to the keeper's judgments. Therefore, even in the case that the rearing conditions are different, the judgment of suitable feed for the rearing conditions of each reared animal only depends on the measurement of the body weight of the domestic animal such as pets conducted by the keeper. Accordingly, as it is pointed that the reason for frequent occurrence of human diseases of civilization is because of enriched nutrition in dietary life, a similar phenomenon has begun to appear in reared pets.

### SUMMARY OF THE INVENTION

[Problems to be solved by the Invention]

Various pets such as dogs and cats and other domestic animals used to be left loose or reared in similar conditions wherein they have contact with nature. However, nowadays, they are reared in narrow enclosures or are put in chains with limited freedom.

It is an urgent problem to improve the feeds for domestic animals hitherto fed, so that the feeds are fit to such rearing conditions.

[Means to Solve the Problem]

As a result of his extensive studies for solving the problem described in the above, the present inventor has found that the above problem can be solved by incorporating an irreversible gel of hydrate of dietary fiber glucomannan into the feeds for domestic animals hitherto fed. Based on such findings, the present invention has been accomplished.

Accordingly, the present invention relates to a dietary fibrous feed for domestic animals, which contains an irreversible gel of hydrate of dietary fiber glucomannan, and such dietary fibrous feed for domestic animals which is in the form contained in a can or a retort pouch.

### DETAILED DESCRIPTION OF THE INVENTION

Currently, in advanced countries in the world, as a measure for overcoming the continuously increasing diseases such as adult diseases caused by nutrition-rich dietary life, the enhancement of intake of dietary fibers and the effective results thereof have been reported one after another, and it has become responsibility for food companies to accomplish a novel manufacturing technology for low-calorie foods in which dietary fibers are put to practical use.

Thus, based on the continuous studies of the theme of intake of dietary fibers for food for a long period of time, the present inventor has succeeded in the development of various low-calorie foods or low-calorie food materials as described below, and have already obtained patents on some of them.

That is, 1. “Immediately soluble glucomannan composition”, which is a food sub-material in the form of immediately water-soluble dietary fiber glucomannan fine powder (Japanese Patent No. 2,619,743); 2. “Dietary fibrous composition for food and method for producing dietary fibrous food”, wherein the food sub-material of immediately water-soluble dietary fiber glucomannan fine powder is put to practical use (Japanese Patent No. 2,741,450, U.S. Pat. No. 5,449,526); 3. “Method for manufacturing fish meat paste product (i.e., surimi-based product) and fish meat paste product-like food”, wherein salt-free ground fish meat and dietary fiber glucomannan are used (Japanese Patent No. 2,770,134, U.S. Pat. No. 5,939,129); 4. “Method for manufacturing salt-free fish meat paste product and salt-free fish meat paste product-like food”, wherein fish meat ground without salt to such extent that a gel-strength enhancer is not required, is used (Japanese Patent No. 2,857,976, U.S. Pat. No. 6,146,684); 5. “Rice gruel and porridge of rice and vegetable”, wherein rice grains are coated with a gel of glucomannan (Japanese Patent Application Laid-Open (kokai) No. 59,525/1995); 6. “Heat-resistant jelly food and method for manufacturing the same”, relating to a low-calorie jelly which does not melt even when heated, using glucomannan as the main raw material (Japanese Patent No. 3,182,543); 7. “Method for manufacturing bubble-containing ice candy”, wherein glucomannan is used as a bubble-forming agent (Japanese Patent Application Laid-Open (kokai) No. 84,561/1996); 8. “Konjak rice cake” excellent in freezing property and the like, wherein glutinous rice powder and a gel of glucomannan hydrate are used as the main raw materials (Japanese Patent Application Laid-Open (kokai) No. 238,631/1997); 9. “Mannan croquette”, wherein a gel of glucomannan hydrate is used as a material (Japanese Patent Application Laid-Open (kokai) No. 165,150/1996); 10. “Method for manufacturing low-calorie noodles”, wherein a gel of gluconan hydrate is used instead of free water (Japanese Patent Application Laid-Open (kokai) No. 191,912/1998); 11. Fine powdery glucomannan composition, and method for producing the same and method for using the same”, wherein problems of properties of glucomannan at practical use in processed food have been solved (Japanese Patent No. 3,023,873); 12. High-quality “dietary fiber bread and method for manufacturing the same”, wherein a gel of glucomannan hydrate is used instead of free water (Japanese Patent No. 3,014,040); 13. “Boiled rice enwrapped in dietary fiber”, which is made by cooking rice grains enwrapped in gel of glucomannan hydrate (Japanese Patent No. 3,182,547); and the like.

The present inventor has developed low-calorie dietary fibrous foods (raw materials), making good use of glucomannan as described above, and as a result of his continued studies, the dietary fibrous feed for domestic animals of the present invention has been accomplished. That is, it is a new practical use of dietary fiber glucomannan.

Incidentally, it has been reported in the specialized field in America and other advanced countries in the world one after another since 1977 that an increased intake of dietary fibers suppresses the increase of human modem diseases and the fibers exhibit excellent health maintaining effects. Thereafter, the quantitative comparison of the dietary intake of dietary fibers has become a topic of conversation until now.

The following will explain glucomannan which is incomparably excellent in amount of dietary intake as compared with other dietary fibers (e.g., guar gum, cylium, seaweeds, and the like). Hereinafter, glucomannan is sometimes referred to simply as “mannan”.

Dietary fibers are generally compared quantatively by the amount used. However, since the use of a large amount thereof affects adversely not only the texture but also the taste of foods in which a dietary fiber has been incorporated, it is impossible to incorporate it in increased intake amounts. Therefore, dietary fibers to be used is limited in amount to 3 to 5% of the main ingredient (s). As compared therewith, glucomannan has such property that it coagulates irreversibly, including water in an amount of 40 or more times the amount thereof, and this property is beyond comparison over other dietary fibrous food materials.

Therefore, with regard to the intake of dietary fibers, as has been described above, the intake amounts have been hitherto uniformly compared in terms of the weight of dry fibers, but insofar as glucomannan is concerned, the weight ratio thereof can be regarded as a different weight ratio from ordinary one. That is, 1 weight part of glucomannan is converted to a coagulate (irreversible gel), including water in an amount of up to as many as 40 times thereof (as many as 40 weight parts of water per 1 part of glucomannan), and then, after it is taken as food and suitably masticated, it reaches intestines to help the excretion of wastes therein, so that it maintains and accelerates the function of body metabolism. Thus, glucomannan can be considered to be one of essential food ingredients effective for living body function.

Generally, as much as nearly half the amount of food taken in remains undigested and is excreted as feces. Therefore, when (irreversible gel of hydrate of) dietary fiber glucomannan mixed with the same amount of other ordinary food is eaten, the amount of such other ordinary food required for reaching feeling of fullness can be reduced to about as little as a half amount as compared with that required conventionally. In other words, the utilization of the amount of the conventional food is nearly doubled. It is expected that this may provide the first ray of hope for the solution of the problem of food shortage in future.

Such superiority of glucomannan is also exhibited in the case of incorporating it into feeds for rearing animals, and thus, glucomannan having such superiority is also expected to provide the first ray of hope for the improvement in nutrition of reared animals and the solution of the problem of feed shortage in future.

Glucomannan remarkably useful as food as described above is present in the form of mucilage particles in the corm of a konjak taro of Amorphophallus konjac, which is a plant belonging to the family Araceae. The above cited “immediately soluble glucomannan composition” is a product obtainable by converting the particles to highly purified dry particles according to a highly specialized technology, further pulverizing the particles into fine powder at a low temperature of liquid nitrogen, and subjecting the powder to a predetermined adjusting treatment.

The following will explain the disagreeable odor peculiar to mannan, which is especially to be noticed.

Glucomannan is a special complex polysaccharide of a polymer wherein glucose and mannose are combined, the acetyl groups present as side chains in the molecule are eliminated upon the action of an alkali, and the linear glucomannan molecules form an associate having a network structure through hydrogen bonding, whereby a gel is formed. Thus, immediately after glucomannan is brought into contact with an alkali, a strong disagreeable odor (vaporized smell) occurs by the action of eliminating acetyl groups. When the odor has not been completely removed, the mannan is unsuitable for sub-material of foods. In the case of konjak products which are traditional foods in Japan, the raw material (purified konjak powder) takes a long period of time for being swollen with water, and then mannan particles swell and become a paste form with the particle state being lost. At this point, an alkali (a coagulating agent) is added to the paste, followed by kneading the mixture to try for the alkali to come into contact with the paste, but a complete contact is impossible physically and such kneading results in coagulation (gelation) with the disagreeable odor being included within the paste.

According to the production method described above, of the “Fine powdery glucomannan composition” (the above-mentioned Japanese Patent No. 3,023,837), purified konjak powder and a milky white liquid of a coagulating agent (calcium hydroxide) are (1) mixed with stirring (about 8 to 10 minutes) to be brought into contact with each other, the stirred mass is (2) allowed to stand for about 50 minutes for the mannan to be swollen and then inmersed in liquid nitrogen, followed by (3) pulverizing under freezing, and the pulverized product was (4) dried in a fluidized bed system, whereby the residual odor (disagreeable odor) disappears during the above steps (1) to (4) concurrently with the vaporization of the moisture and no occurrence of the odor is observed thereafter. This is because the fine powdery glucomannan present in the “Fine powdery glucomannan composition” comes into contact with the alkali by stirring, immediately the glucomannan is brought into contact with water, and therefore, the glucomannan dissolves easily to form a hydrate gel. On the contrary, the raw material (purified konjak powder) for ordinary konjak products, traditional foods in Japan, is inevitably tried to be brought into contact with an alkali, not at the point in time of such stirring but at the point in time of such kneading after the particles are swollen as described above, so that the disagreeable odor cannot escape from the inside of the paste and remains therein. Therefore, since usual raw material of konjak has such a defect for the use as a food sub-material, it is currently still used only in konjak products which are traditional foods in Japan.

According to the present invention, feedstuff is fixed so as to be an appropriate hardness by incorporating an irreversible gel of glucomannan hydrate. As glucomannan for preparing a gel of glucomannan hydrate, the “immediately soluble glucomannan composition” described above may be mentioned as the most preferred one. The main reason is that no disagreeable odor peculiar to glucomannan remains, and the way of its use is simple and easy. Since reared animals have a better sense of smell than human beings, the disagreeable odor, the so-called alkali odor, resulting from a chemical action is an important point to be overcome in the preparation of animal feeds, which can be easily dissolved with the “Immediately soluble glucomannan composition”.

In the preparation of the dietary fibrous feeds for reared animals of the present invention using the “Immediately soluble glucomannan composition”, an alkali is mixed therewith and water is further added thereto, followed by stirring. The step is carried out for the purpose of the dissolution of glucomannan through hydration and its gelation, and the stirring for that purpose results in a uniform gel of glucomannan hydrate in a homogeneous state only in 3 to 4 minutes. In this state, other raw materials for feeds are mixed therewith, and the mixture was heated to prepare a dietary fibrous feeds for reared animals of the present invention. Glucomanan hydrate is, of course, to be used in such range of amount that the amount is selected from the range wherein the final products of the resulting feeds are fit to the taste of reared animals and do not impair their appetites. The glucomannan hydrate after heated gets irreversibly gelled, whereby the physical properties of hardness or softness can be optionally imparted to the final product feeds, also depending on the ratio of glucomannan and water.

In the following will be described the raw materials for the feeds (i.e., feedstuff) of the present invention, including a gel of glucomannan hydrate. With regard to the current conventional feeds, the nutrition and taste have been studied for each animal to be fed, and market competition has been developed. In the preparation of low-calorie feeds of the present invention, making good use of the dietary fiber mannan, the feeds of the present invention can be prepared by the simple adjusting of the raw materials, making good use of a commercialized nutrition balance as it is (Example 1 given later). That is, the composition of the raw materials of a conventional feed can be used as it is with the exception that the gel of glucomannan hydrate is added thereto. This is because glucomannan (an irreversible gel of hydrate thereof) does not adversely affect the appetite and intake amount of a reared animal except that it makes the feeds containing it, low-calorie.

Furthermore, the aimed-at feeds can be also conveniently and easily produced even according to the procedure of directly adding the powder of the “Fine powdery glucomannan composition” (Japanese Patent No. 3,023,837 mentioned above) invented by the present inventor in the powder state to other raw materials in the production of the feeds with the use of water (moisture), when followed by subsequently using water (moisture) and heating. This is because the “Fine powdery glucomannan composition” has been produced with a coagulating agent being already added. It is needless to say that glucomannan in any other forms can be also used as a raw material for preparing feeds of the present invention, as far as it can achieve the intended purpose of the present invention.

The gel of glucomanan hydrate causes an irreversible gelation, as has been described in the above when it is mixed with other raw materials followed by heating, whereby the irreversiblegel of glucomannan hydrate is incorporated into the final product, a dietary fibrous feeds of the present invention, in this state.

The degree of the heating must be to such extent that an irreversible gelation of the gel of glucomannan hydrate can be caused, but in the case that there is contained in other raw materials a raw material requiring heating (e.g., raw sardine in Example 2 given later), the heating has to be carried out to such extent that the heating can also satisfy that required by the raw material.

Nowadays, feeds for reared animals are put in distribution in the form of canned products or small rice-cake cubes or pellet-type dry food or semi-dried state contained in a moistureproof bag. The feeds for reared animals of the present invention can be, of course, prepared in the form contained in a can by retort treatment or in a retort pouch, too. In this case, it is needless to say that the heating for irreversible gelation of the gel of glucomannan hydrate can be carried out simultaneously by the heating at the retort treatment without carrying out the former heating as an independent step (Examples 1 and 2 given later).

### EXAMPLES

In the following will be described the present invention in greater detail with reference to Examples.

### Example 1 (Dog Food)

This example relates to the production of a low-calorie dog food using a conventional dog food (a ready-made canned product containing 400 g).

The “Immediately soluble glucomannan composition” (14 g) prepared by the method described in Example 3 of the specification of the above Japanese Patent No. 2619743, starch (5.6 g), and calcium hydroxide (0.4 g) (20 g in total) were poured portionwise (for preventing the formation of “mamako”, i.e., an unmixed-in lump of flour) into 20 times in terms of weight amount, of water (400 g) in a bowl with stirring with the use of a whisk to disperse them, and then the whole mass was stirred for about 3 minutes with a food mixer (550 rpm) to form a paste-like gel (420 g) of mannan hydrate. After about 30 minutes of standing, a 200 g portion of the gel was taken out and added to a ready-made product (described below) of dog food (400 g), and the whole was lightly kneaded with a soft spatula (for about 1 minute). After about 10 minutes of standing, the remaining gel of mannan hydrate (220 g) was added thereto and the whole mass was kneaded (for about 30 seconds). The resulting kneaded mass was packed in five (5) cylindrical pressure-resistant and heat-resistant bags (retort pouches) in an amount of 160 g per one (1) bag (800 g in total), both ends of each pouch were closed, and each pouch was subjected to a retort treatment (Fo5), whereby a dog food in retort pouch was obtained.

This method of adding and kneading the gel of mannan hydrate separately twice is also effective as a means for combining fat-rich raw materials for feeds.

The dog food in retort pouch had been prepared by adding almost the same amount (105%) of the gel of mannan hydrate to a ready-made product (a can containing 400 g of a brand name “Champ” sold by Heinz Japan, Ltd.), but the hardness of the dog food according to the present invention at eating was improved in comparison with the ready-made product, and the color and the aromatic smell were not deteriorated, as well as the appearance was not inferior to the ready-made one.

This food was fed to a pet dog instead of the “Champ” for several days, but both of the appetite and the intake amount did not change and the dog ate similarly as before.

Thus, the preparation of dietary fibrous feeds having a calorie lowered by a half was succeeded in.

### Example 2 (Cat Food)

Raw sardine (80 g), oligosaccharide (15 g), and shavings of dried bonito (5 g) (100 g in total) were crushed with a food cutter for about 30 seconds, and a salt-free ground fish meat product (200 g) (not yet heated) obtained by the method described in Example 1 of the specification of the above Japanese Patent No. 2857986 was mixed therewith, followed by lightly kneading with a resinous spatula. The kneaded mass (300 g) was kneaded (for 30 seconds) together with the gel of mannan hydrate (240 g) formed by the same method as in Example 1. The resulting kneaded mass (540 in total) was packed in four (4) cylindrical pressure-resistant and heat-resistant bags (retort pouches) in an amount of 130 g per one (1) bag (520 g in total), both ends of each pouch were closed, and each pouch was subjected to a retort treatment (Fo5), whereby a cat food in retort pouch (was obtained).

The cat food in retort pouch had been experimentally prepared by adding the gel of mannan hydrate in an amount of 80% to raw materials mainly made of fishmeat, but the experimental product had an improved hardness at eating, good color, and the preferable aromatic smell derived from the fresh sardine and the shavings of dried bonito in comparison with a commercial cat food, MARUHA “Kinkan” (manufactured by Maruha Corporation), as well as the appearance was not inferior to the commercial one.

When about 80 g of this food was fed to a pet cat to which 80 g of the above MARUH “Kinkan” had been hitherto fed, the cat ate immediately the food completely.

[Effects of the Invention]

With respect to the adult diseases and diseases of civilization frequently occurring owing to the nutrition-rich dietary life in these days, the necessity of enhancing the intake of dietary fibers was reported along with the effectiveness as a correspondence to the time (America Senate Nutrition Special Committee in 1977). Since then, researches on the method for taking dietary fibers as foods have been actively carried out in advanced countries and others, and along with the adjustment of intake calories corresponding to each dietary culture, the good results have been reported.

However, feeds for reared animals such as pets are only evaluated as a “general nutritive food”, and is still within the nutrition-rich state even to this day.

According to the present invention, there can be easily provided low-calorie feeds maintaining the balance of such “general nutritive food”, making good use of dietary fibers. As a result, the suppression or dissolution of the obesity can be easily effected by feeding such feeds to reared animals, so that the keeper can fulfill his or her keeper's responsibility. Thereby, the human society can also learn the necessity of ingestion of dietary fibers from fondled pets and can obtain a first step for the walk toward health.

1. A dietary fibrous feed for domestic animals comprising an irreversible gel of glucomaman hydrate.

2. The dietary fibrous feed for domestic animals of claim 1 which is in the form contained in a can or a retort pouch.

3. A method of producing the dietary fibrous feed for domestic animals of claim 1 or 2 which method comprises heating a feedstuff mixed with the gel of glucomannan hydrate, whereby the gel of glucomannan is allowed to be irreversibly gelled.
